(19) United States
(12) Patent Application Publication
(10) Pub. No.: US 2021/0191146 A1
(43) Pub. Date: Jun. 24, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/875,158

(22) Filed: May 15, 2020

(30) Foreign Application Priority Data
Dec. 19, 2019 (JP) 2019-229721

(51) Int. Cl. G02B 30/56; G06F 3/01; G02B 30/52; G02B 30/40; G06K 9/00

(52) U.S. Cl. CPC G02B 30/56; G06F 3/013; G06K 9/00315; G02B 30/40; G02B 30/52

(57) ABSTRACT

An information processing apparatus includes a processor configured to, in accordance with the state of a person in the vicinity of an image, instruct that a change be made to the image, the image being an image to be formed in the air, the change being one of a change in the dimensionality of the image and a change in the size of the image.

### CROSS-REFERENCE TO RELATED APPLICATIONS

This application is based on and claims priority under 35 USC 119 from Japanese Patent Application No. 2019-229721 filed Dec. 19, 2019.

### BACKGROUND

### (i) Technical Field

The present disclosure relates to an information processing apparatus, and a non-transitory computer readable medium.

### (ii) Related Art

To date, various techniques have been proposed to form images in the air. Some of these techniques are now being used in fields such as advertising and gaming (see, for example, Japanese Unexamined Patent Application Publication No. 2007-044241).

To be effective, advertisements need to be observed by people. The same is true for advertisement images formed in the air.

### SUMMARY

Aspects of non-limiting embodiments of the present disclosure relate to enabling an image in the air to be represented in diverse ways compared with when the image continues to be represented in a fixed way.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, in accordance with the state of a person in the vicinity of an image, instruct that a change be made to the image, the image being an image to be formed in the air, the change being one of a change in the dimensionality of the image and a change in the size of the image.

### BRIEF DESCRIPTION OF THE DRAWINGS

Exemplary embodiments of the present disclosure will be described in detail based on the following figures, wherein:

FIG. 1 illustrates an exemplary configuration of an information processing system according to exemplary embodiments;

FIG. 2 is a flowchart illustrating an exemplary process that switches the shapes of aerial images in accordance with Exemplary Embodiment 1;

FIGS. 3A and 3B each illustrate an example of a predetermined area used for a determination at step 2, of which FIG. 3A illustrates a case in which a person is determined to be not located within the predetermined area, and FIG. 3B illustrates a case in which a person is determined to be located within the predetermined area;

FIGS. 4A and 4B each illustrate another example of a predetermined area used for the determination at step 2, of which FIG. 4A illustrates a case in which a person is determined to be not located within the predetermined area, and FIG. 4B illustrates a case in which a person is determined to be located within the predetermined area;

FIGS. 5A to 5C each illustrate how the shapes of aerial images formed in the air are switched, of which FIG. 5A illustrates a case in which no person is located within an area captured by a camera, FIG. 5B illustrates a case in which a person is located outside the area used for the determination at step 2, and FIG. 5C illustrates a case in which a person is located inside the area used for the determination at step 2;

FIGS. 6A to 6C each illustrate another example of how the shapes of aerial images formed in the air are switched, of which FIG. 6A illustrates a case in which no person is located within an area captured by a camera, FIG. 6B illustrates a case in which a person is located outside the area used for the determination at step 2, and FIG. 6C illustrates a case in which a person is located inside the area used for the determination at step 2;

FIG. 7 is a flowchart illustrating an exemplary process that switches the shapes of aerial images in accordance with Exemplary Embodiment 2;

FIGS. 8A to 8C each illustrate how the shapes of aerial images formed in the air are switched, of which FIG. 8A illustrates a case in which a person□s gaze is directed not toward an aerial image, FIG. 8B illustrates a case in which a person□s gaze is directed toward an aerial image, and FIG. 8C illustrates a case in which a person□s gaze is directed toward an aerial image;

FIGS. 9A to 9C each illustrate another example of how the shapes of aerial images formed in the air are switched, of which FIG. 9A illustrates a case in which a person□s gaze is directed not toward an aerial image, FIG. 9B illustrates a case in which a person□s gaze is directed toward an aerial image, and FIG. 9C illustrates a case in which a person□s gaze is directed toward an aerial image;

FIGS. 10A to 10C each illustrate an example in which an aerial image formed in three dimensions is enlarged in volume with the passage of time, of which FIG. 10A illustrates an example in which the aerial image is enlarged in volume in one direction, FIG. 10B illustrates an example in which the aerial image is enlarged in volume in two directions, and FIG. 10C illustrates an example in which the aerial image is enlarged in volume in three directions;

FIGS. 11A to 11C each illustrate a case in which, at the beginning of enlargement in volume, an aerial image is located at the same position as Position P1 where the aerial image has been previously formed in two dimensions, of which FIG. 11A illustrates the position and shape of the aerial image at time T1, FIG. 11B illustrates the position and shape of the aerial image at time T2, and FIG. 11C illustrates the position and shape of the aerial image at time T3;

FIGS. 12A to 12C each illustrate a case in which, at the beginning of enlargement in volume, an aerial image is located at a position different from Position P1 where the aerial image has been previously formed in two dimensions, of which FIG. 12A illustrates the position and shape of the aerial image at time T1, FIG. 12B illustrates the position and shape of the aerial image at time T2, and FIG. 12C illustrates the position and shape of the aerial image at time T3;

FIGS. 13A to 13D each illustrate an example of how to direct a person toward Position P1 where a two-dimensional aerial image is formed, of which FIG. 13A illustrates the shape of an aerial image immediately after being formed in three dimensions, FIG. 13B illustrates the shape of the aerial image with the person moving closer to Position P1, FIG. 13C illustrates the shape of the aerial image with the person moving further closer to Position P1, and FIG. 13D illustrates the shape of the aerial image with the person moving further closer until the person is just in front of Position P1;

FIGS. 14A to 14E each illustrate another example of how to direct a person toward Position P1 where a two-dimensional aerial image is formed, of which FIG. 14A illustrates the shape of an aerial image immediately after being formed in three dimensions, FIG. 14B illustrates the shape of the aerial image with the person moving closer to Position P1, FIG. 14C illustrates the shape of the aerial image with the person moving further closer to Position P1, FIG. 14D illustrates the shape of the aerial image with the person moving further closer to Position P1, and FIG. 14E illustrates the shape of the aerial image with the person moving further closer until the person is just in front of Position P1;

FIG. 15 illustrates an example in which an aerial image formed in three dimensions is enlarged in volume with the center of the aerial image fixed in position;

FIGS. 16A to 16C each illustrate an example in which an object constituting an aerial image formed in three dimensions is changed as the aerial image is enlarged in volume, of which FIG. 16A illustrates an exemplary object constituting the aerial image with the smallest volume, FIG. 16B illustrates an exemplary object constituting the aerial image with the second largest volume, and FIG. 16C illustrates an exemplary object constituting the aerial image with the largest volume;

FIGS. 17A to 17C each illustrate an example in which an aerial image formed in three dimensions is reduced in volume with the passage of time, of which FIG. 17A illustrates an example in which the aerial image is reduced in volume in one direction, FIG. 17B illustrates an example in which the aerial image is reduced in volume in two directions, and FIG. 17C illustrates an example in which the aerial image is reduced in volume in three directions;

FIGS. 18A to 18C each illustrate a case in which, at the beginning of reduction in volume, an aerial image is located at the same position as Position P1 where the aerial image has been previously formed in two dimensions, of which FIG. 18A illustrates the position and shape of the aerial image at time T1, FIG. 18B illustrates the position and shape of the aerial image at time T2, and FIG. 18C illustrates the position and shape of the aerial image at time T3;

FIGS. 19Ato 19C each illustrate a case in which, at the beginning of reduction in volume, an aerial image is located at a position different from Position P1 where the aerial image has been previously formed in two dimensions, of which FIG. 19A illustrates the position and shape of the aerial image at time T1, FIG. 19B illustrates the position and shape of the aerial image at time T2, and FIG. 19C illustrates the position and shape of the aerial image at time T3;

FIGS. 20A to 20D each illustrate an example of how to direct a person toward Position P1 where a two-dimensional aerial image is formed, of which FIG. 20A illustrates the shape of an aerial image immediately after being formed in three dimensions, FIG. 20B illustrates the shape of the aerial image with the person moving closer to Position P1, FIG. 20C illustrates the shape of the aerial image with the person moving further closer to Position P1, and FIG. 20D illustrates the shape of the aerial image with the person moving further closer until the person is just in front of Position P1;

FIGS. 21A to 21E each illustrate another example of how to direct a person toward Position P1 where a two-dimensional aerial image is formed, of which FIG. 21A illustrates the shape of an aerial image immediately after being formed in three dimensions, FIG. 21B illustrates the shape of the aerial image with the person moving closer to Position P1, FIG. 21C illustrates the shape of the aerial image with the person moving further closer to Position P1, FIG. 21D illustrates the shape of the aerial image with the person moving further closer to Position P1, and FIG. 21E illustrates the shape of the aerial image with the person moving further closer until the person is just in front of Position P1;

FIG. 22 illustrates an example in which an aerial image formed in three dimensions is reduced in volume with the center of the aerial image fixed in position;

FIGS. 23A to 23C each illustrate an example in which an object constituting an aerial image formed in three dimensions is changed as the aerial image is reduced in volume, of which FIG. 23A illustrates an exemplary object constituting the aerial image with the largest volume, FIG. 23B illustrates an exemplary object constituting the aerial image with the second largest volume, and FIG. 23C illustrates an exemplary object constituting the aerial image with the smallest volume; and

FIG. 24 is a flowchart illustrating an exemplary process that switches the contents of aerial images in accordance with Exemplary Embodiment 4.

### DETAILED DESCRIPTION

Exemplary embodiments of the present disclosure will be described below with reference to the drawings.

### Exemplary Embodiment 1

### System Configuration

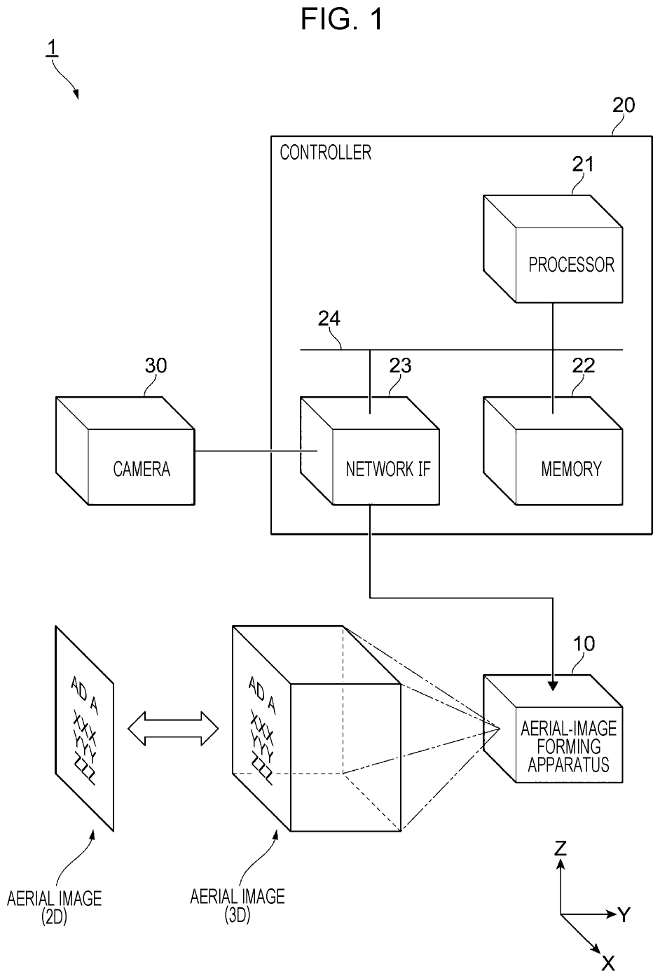

FIG. 1 illustrates an exemplary configuration of an information processing system 1 according to exemplary embodiments.

The information processing system 1 illustrated in FIG. 1 includes an aerial-image forming apparatus 10, a controller 20, and a camera 30. The aerial-image forming apparatus 10 forms an image (to be also referred to as “aerial image” hereinafter) such that the image floats up in the air. The controller 20 controls the aerial-image forming apparatus 10 or other components. The camera 30 captures an image of the area in the vicinity of an aerial image.

The term “person” as used in the exemplary embodiments refers to both a person observing an aerial image and a person not observing an aerial image.

In the exemplary embodiments, an aerial image is used to present an advertisement or other information. In the exemplary embodiments, advertisements refer to all items of content including information used to draw attention to, for example, a product or a service. In other words, an advertisement may be a portion of an aerial image. In the following description of the exemplary embodiments, an aerial image used for advertising will be also referred to as an advertisement image. It is to be noted, however, that an advertisement is an example of information represented by an aerial image. Information represented by an aerial image may not necessarily be an advertisement.

An aerial image may be of any shape, and may have a solid or planar shape. Examples of solid shapes include a sphere, a polyhedron, a cylinder or other such curved solid, and the shape of an object such as a person, an animal, an electrical appliance, or a fruit.

Examples of planar shapes include a circle, a polygon, and the shape of an object such as a person, an animal, an electrical appliance, or a fruit. The terms “person” and “animal” as used herein may include imaginary characters or creatures.

An aerial image formed in the air may not necessarily be an image defining the surfaces of a solid but may be made up of an image defining the surfaces of a solid and an image corresponding to its interior. In other words, for example, an aerial image may be represented by voxel data or other such data with image attributes given not only to its three-dimensional surfaces but also to its internal structure.

The aerial image according to the exemplary embodiments may be a static image or a moving image.

The aerial-image forming apparatus 10 according to the exemplary embodiments is an apparatus that directly forms an aerial image in the air. Various methods for forming an aerial image have already been proposed, and some of these methods have been put into practical use.

Examples of methods for forming an aerial image include use of a half mirror, use of a beam splitter, use of a minute mirror array, use of a minute lens array, use of a parallax barrier, use of plasma emission, and use of a hologram. An aerial image generated by such a method allows a person to pass through the aerial image.

An example of the aerial-image forming apparatus 10 that generates an aerial image that does not allow a person to pass therethrough is a projector that projects an image onto a screen existing in the real space. Other examples of the aerial-image forming apparatus 10 include an apparatus that moves an array of light-emitting elements in the real space at high speed, and uses the resulting persistence of vision effect to allow a person to see an aerial image.

The aerial-image forming apparatus 10 according to the exemplary embodiments is capable of forming both a planar aerial image and a solid aerial image in the air. A planar aerial image is an example of an aerial image formed in two dimensions, and a solid aerial image is an example of an aerial image formed in three dimensions. In this regard, cases in which an aerial image is formed in two dimensions also include when an image is formed in only one face of an aerial image formed in three dimensions. In this sense, an aerial image formed in two dimensions also represents one form of an aerial image formed in three dimensions.

It is to be noted, however, that in the exemplary embodiments, a planar shape may be any shape recognized by a person as a plane, and does not need to be a plane in the mathematical sense. Likewise, in the exemplary embodiments, a solid shape may be any shape recognized by a person as a solid, and does not need to be a solid in the mathematical sense. For example, a curved surface obtained by bending a rectangular flat plate may be regarded as a plane, or may be regarded as a solid.

The controller 20 includes a processor 21, a memory 22, a network interface (IF) 23, and a signal line 24. The processor 21 executes a program to thereby control generation of aerial image data. The memory 22 stores information such as a program or various data. The network IF 23 is used to achieve communication with the external environment. The signal line 24 is a bus or other such signal line that connects the above-mentioned components of the controller 20. The controller 20 is an example of an information processing apparatus.

The processor 21 is, for example, a CPU. The memory 22 includes, for example, a read only memory (ROM) in which a basic input output system (BIOS) or other information is stored, a random access memory (RAM) used as a work area, and a hard disk device in which a basic program, an application program, or other information is stored.

It is to be noted, however, that the above description does not preclude inclusion of the ROM or RAM in a portion of the processor 21. The processor 21 and the memory 22 constitute a computer.

The camera 30 is used to capture an image of a person present in the vicinity of an aerial image. In the exemplary embodiments, the camera 30 is used to acquire, for example, information related to the respective positions of an aerial image and a person, information related to the direction of a person□s gaze, or information related to a person□s facial expression. Such information represents an example of the state of a person in the vicinity of an aerial image. The vicinity of an aerial image may include the aerial image.

Examples of information related to the respective positions of an aerial image and a person in this case include an approximate distance between the aerial image and the person, and the direction of the person□s movement.

Exemplary methods for measuring distance include, in addition to measuring distance by use of a pair of images captured by a stereo camera, measuring distance by use of a single color image captured by a monocular camera. Techniques for measuring distance by use of a monocular camera have already been put into practical use. If a monocular camera is used, distance is measured from information about blurring that appears in a color image captured through a color filter divided into two colors.

For distance measurement, it is also possible to use, for example, a distance-measuring image sensor, or a laser distance meter that measures the time it takes for a radiated beam of light to return after reflecting off a person.

The estimation or calculation of information such as the positional relationship between an aerial image and a person, the direction of a person□s gaze, or a person□s facial expression is executed by the processor 21. Switching of Aerial Image Shapes

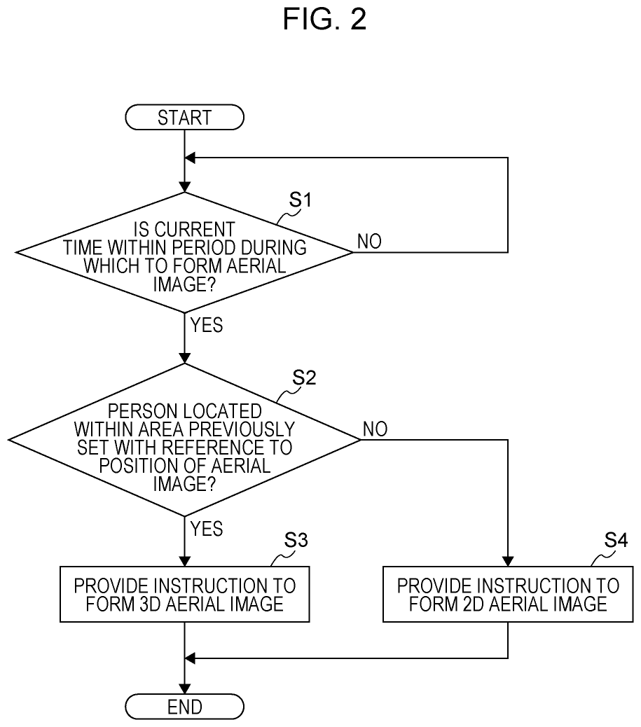

FIG. 2 is a flowchart illustrating an exemplary process that switches the shapes of aerial images in accordance with Exemplary Embodiment 1. The process illustrated in FIG. 2 is implemented through execution of a program by the processor 21 (see FIG. 1).

First, the processor 21 determines whether the current time is within the period during which an aerial image is to be formed (to be referred to as formation period hereinafter) (step 1). If a negative determination is made at step 1, the processor 21 repeats the determination of step 1. If an aerial image formed in the air exists at the time when a negative determination is made at step 1, the processor 21 causes the formation of the aerial image to end.

A negative determination is made at step 1 if, for example, the time at which the determination is made does not fall within a period set by a contract as a period during which to place an advertisement.

If an affirmative determination is made at step 1, the processor 21 determines whether a person is located within an area previously set with reference to the position of the aerial image (step 2). In Exemplary Embodiment 1, the position where a person is located is determined by processing an image captured by the camera 30 (see FIG. 1). Of course, the person□s position is determined through execution of a program by the processor 21.

If an affirmative determination is made at step 2, the processor 21 instructs that a three-dimensional aerial image be formed (step 3). Specifically, the processor 21 forms advertisement data in a three-dimensional shape, and outputs the formed advertisement data to the aerial-image forming apparatus 10 (see FIG. 1).

If a negative determination is made at step 2, the processor 21 instructs that a two-dimensional aerial image be formed (step 4). Specifically, the processor 21 forms advertisement data in a two-dimensional shape, and outputs the formed advertisement data to the aerial-image forming apparatus 10.

Although the foregoing description of FIG. 2 assumes, as a precondition for the determination at step 2, that the position of a person is determined, it may be determined instead whether some mobile object is located within a predetermined area. This configuration makes it possible to omit the process of determining whether a person appears in an image captured by the camera 30. Furthermore, this configuration allows an aerial image to be switched to a three-dimensional image also when a baby stroller, a shopping cart, a pet, or other such object is located within a predetermined area.

The process illustrated in FIG. 2 is repeatedly executed by the processor 21.

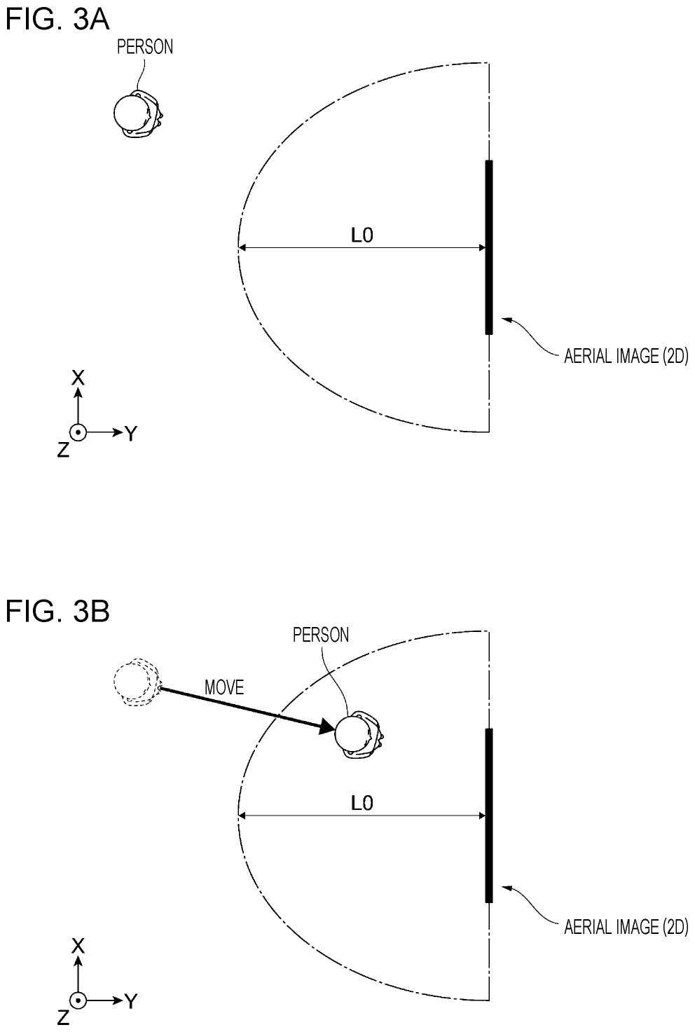

FIGS. 3A and 3B each illustrate an example of a predetermined area used for the determination at step 2. FIG. 3A illustrates a case in which a person is determined to be not located within the predetermined area, and FIG. 3B illustrates a case in which a person is determined to be located within the predetermined area.

The aerial image in FIGS. 3A and 3B is formed in the plane defined by the X- and Z-axes. Thus, FIGS. 3A and 3B depict a two-dimensional aerial image. Specifically, the aerial image is assumed to be a rectangular aerial image.

In Exemplary Embodiment 1, the area used for the determination at step 2 is set with reference to the position where the two-dimensional aerial image is formed. In Exemplary Embodiment 1, the basic shape of an aerial image is assumed to be two-dimensional. If the position where the two-dimensional aerial image is formed moves with time or other factors, the reference position used in setting the predetermined area is also changed.

In the area illustrated in FIGS. 3A and 3B, the aerial image is represented as being seen from above. The area illustrated in FIGS. 3A and 3B has a shape obtained by cutting an ellipse in half along the minor axis, with the major axis being located forward of the aerial image. In other words, the minor axis is located within the plane in which the aerial image is formed.

In FIGS. 3A and 3B, L0 represents the length of the major axis. It is to be noted, however, that the area used for the determination at step 2, or a marking or other indication of the outer edges of the area is not necessarily provided in the actual space. Therefore, the determination at step 2 is not an exact determination in a strict sense. Even if the determination is not an exact in a strict sense, this does not pose any practical problem. The area used for the determination at step 2 is, for example, set in advance for an image captured from where the camera 30 (see FIG. 1) is installed.

In any case, if a person is located outside the area represented by the alternate long and short dash line in each of FIGS. 3A and 3B, a negative determination is made at step 2. Conversely, if a person is located inside the area represented by the alternate long and short dash line in each of FIGS. 3A and 3B, an affirmative determination is made at step 2.

The foregoing description of FIGS. 3A and 3B is directed to an example in which as seen from above, the area mentioned above has a shape obtained by cutting an ellipse in half. However, the above-mentioned area may be of any shape. For example, the above-mentioned area may have a sectoral shape, a rectangular shape, or a semi-circular shape.

In FIGS. 3A and 3B, in setting the area used for the determination at step 2, the side from which the aerial image is to be basically observed is defined as front side. Alternatively, the area used for the determination at step 2 may be set on both the front and back sides relative to the aerial image. This is because a portion of the aerial image is also observable from the back side, unlike when the aerial image is displayed by using a physical display.

The side from which the aerial image is to be basically observed refers to the side from which, if the aerial image contains letters, the letters can be correctly read.

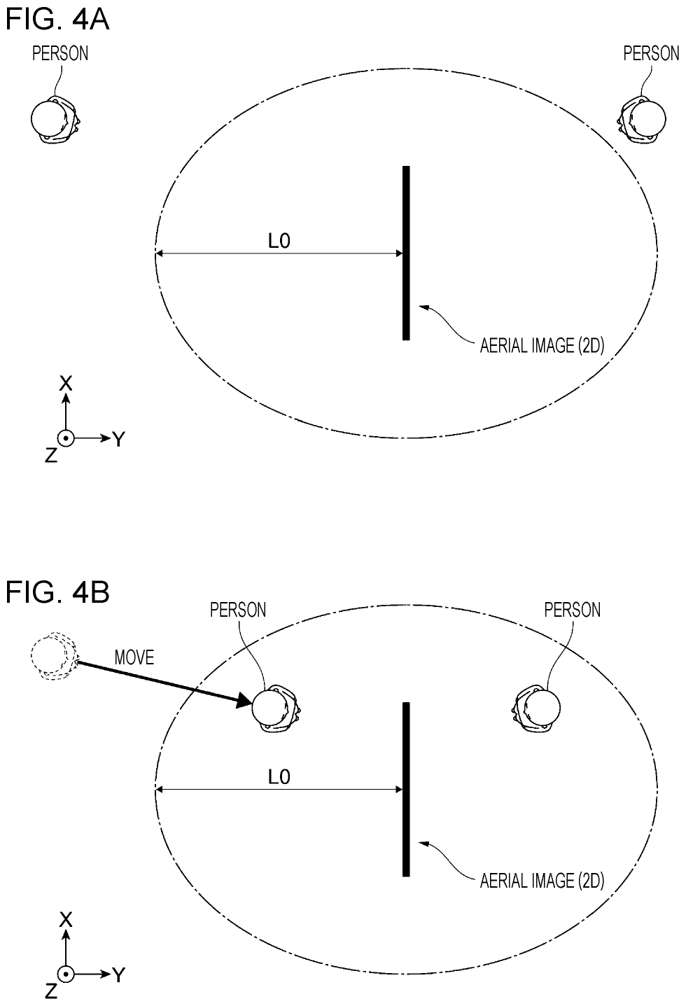

FIGS. 4A and 4B each illustrate another example of a predetermined area used for the determination at step 2. FIG. 4A illustrates a case in which a person is determined to be not located within the predetermined area, and FIG. 4B illustrates a case in which a person is determined to be located within the predetermined area. In FIGS. 4A and 4B, features corresponding to those in FIGS. 3A and 3B are denoted by the corresponding reference signs.

The area illustrated in FIGS. 4A and 4B has the shape of an ellipse covering the entire aerial image.

Although FIGS. 3A and 3B and FIGS. 4A and 4B each depict the shape of the above-mentioned area with the aerial image seen from above, the area used for the determination at step 2 may be set also with respect to the Z-axis direction. That is, the area used for the determination at step 2 may not necessarily have a planar shape but may be set as a solid shape.

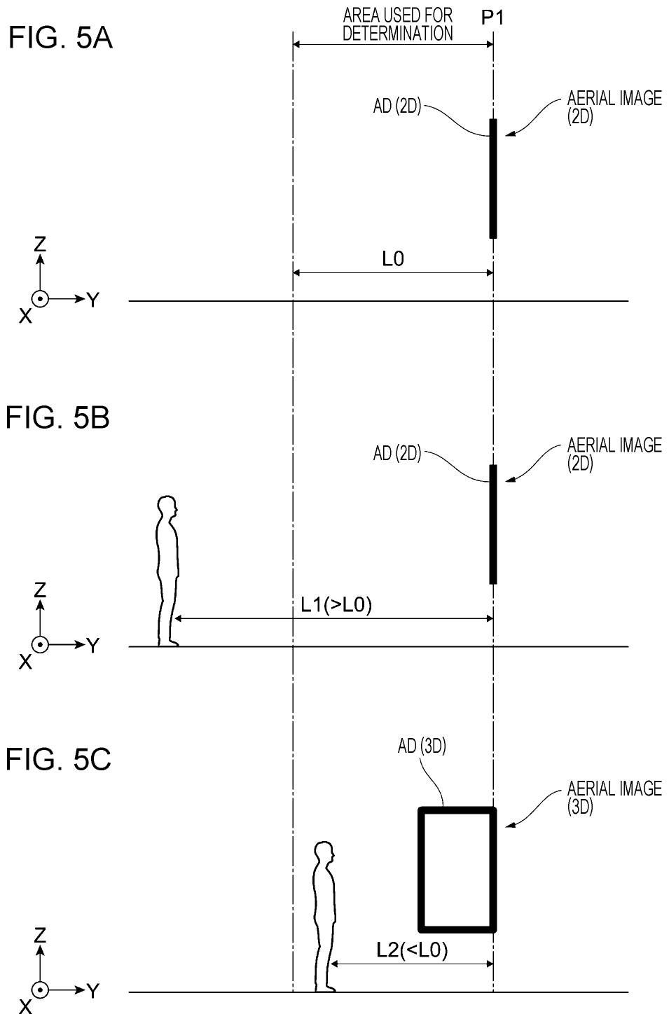

FIGS. 5A to 5C each illustrate how the shapes of aerial images formed in the air are switched. FIG. 5A illustrates a case in which no person is located within an area captured by the camera 30 (see FIG. 1), FIG. 5B illustrates a case in which a person is located outside the area used for the determination at step 2, and FIG. 5C illustrates a case in which a person is located inside the area used for the determination at step 2.

In FIGS. 5A to 5C, P1 represents the position where a two-dimensional aerial image is formed. In the case of FIGS. 5A to 5C as well, the area used for the determination mentioned above is only the area adjacent to one face of the aerial image, which is defined as the area on the observation side from which the aerial image is to be basically observed.

In the case of FIG. 5A, although no one is present in the vicinity of Position P1, a two-dimensional aerial image is formed at Position P1. In Exemplary Embodiment 1, if it is currently during the formation period in which an aerial image is to be formed, the aerial image is formed irrespective of whether a person is present in the vicinity of Position P1.

In the case of FIG. 5B, a person is located in the vicinity of Position P1. In this case, however, a distance Ll, which is the distance in the Y-axis direction between the person and the aerial image, is greater than a distance L0 that defines the outer boundary of the area used for the determination at step 2 (see FIG. 2). Thus, the aerial image formed in the area remains two-dimensional.

In the case of FIG. 5C, a distance L2, which is the distance between a person and the position where the two-dimensional aerial image is formed, is less than the distance L0 that defines the outer boundary of the area used for the determination at step 2. Thus, the aerial image is switched to a three-dimensional image.

That is, in Exemplary Embodiment 1, if a person enters inside an area set in the vicinity of an aerial image that is being formed in two dimensions, the processor 21 (see FIG. 1) switches the shape of the aerial image from two-dimensional to three-dimensional. This change in shape draws the attention of the person, thus increasing the likelihood of the aerial image being observed by the person. This means that the chance of the advertisement being observed by the person may be increased.

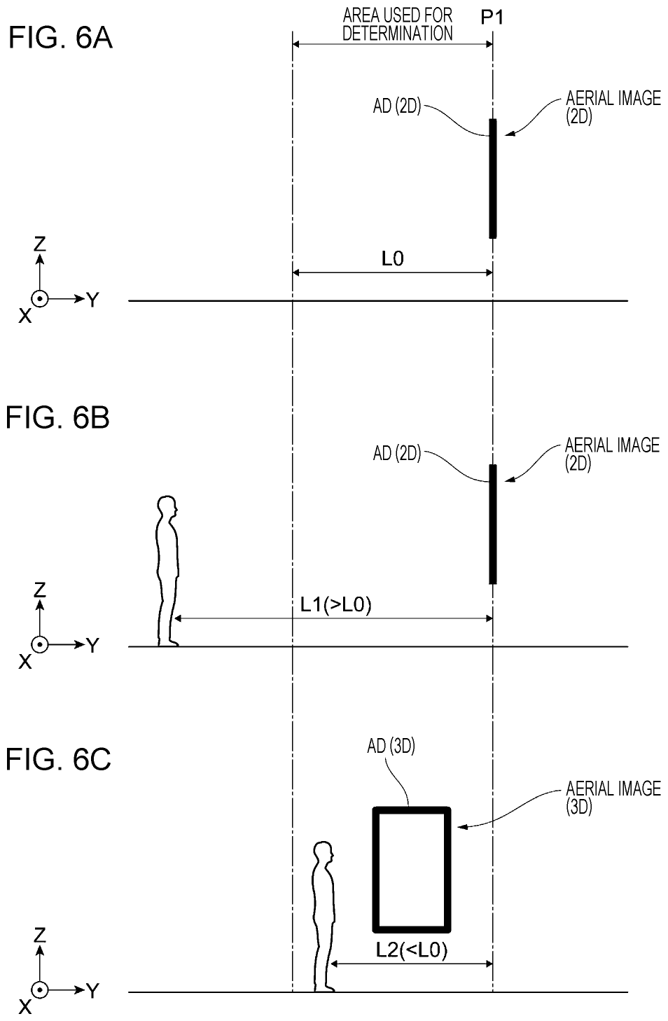

FIGS. 6A to 6C each illustrate another example of how the shapes of aerial images formed in the air are switched. FIG. 6A illustrates a case in which no person is located within an area captured by the camera 30 (see FIG. 1), FIG. 6B illustrates a case in which a person is located outside the area used for the determination at step 2, and FIG. 6C illustrates a case in which a person is located inside the area used for the determination at step 2. In FIGS. 6A to 6C, features corresponding to those in FIGS. 5A to 5C are denoted by the corresponding reference signs.

In FIGS. 6A to 6C, the image formed in three dimensions is located at a position different from the position in FIGS. 5A to 5C. In FIGS. 5A to 5C, the far side of the three-dimensional aerial image as seen from the person includes the plane in which the two-dimensional image is formed, or the far side of the three-dimensional aerial image is located near the plane.

However, in FIGS. 6A to 6C, the three-dimensional aerial image is formed at a position closer to the person than the position illustrated in FIGS. 5A to 5C is. In other words, if a three-dimensional aerial image is to be formed in FIGS. 6A to 6C, the three-dimensional aerial image appears immediately near the person. This is expected to increase the person□s interest in the aerial image.

### Exemplary Embodiment 2

The following describes Exemplary Embodiment 2 that uses the information processing system 1 (see FIG. 1) illustrated in FIG. 1.

Exemplary Embodiment 2 also uses the information processing system 1 illustrated in FIG. 1. It is to be noted, however, that in Exemplary Embodiment 2, the process used in switching the shapes of aerial images formed in the air differs from the process in Exemplary Embodiment 1.

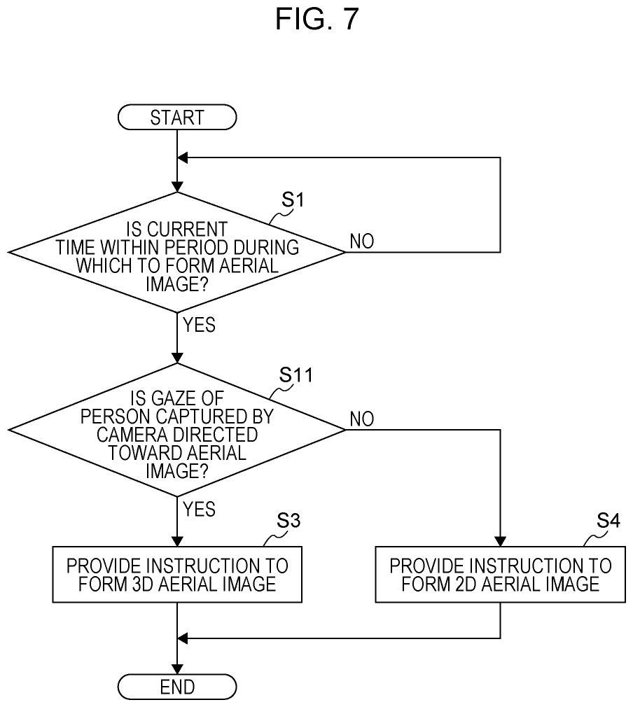

FIG. 7 is a flowchart illustrating an exemplary process that switches the shapes of aerial images in accordance with Exemplary Embodiment 2. The process illustrated in FIG. 7 is implemented through execution of a program by the processor 21 (see FIG. 1). In FIG. 7, features corresponding to those in FIG. 2 are denoted by the corresponding reference signs.

First, the processor 21 determines whether the current time is within the period during which an aerial image is to be formed (i.e., formation period) (step 1). This process is the same as that in Exemplary Embodiment 1. That is, the processor 21 repeats the determination of step 1 as long as the result of determination at step 1 is negative.

It is to be noted, however, that if an affirmative determination is made at step 1, the processor 21 determines whether the gaze of a person captured by the camera 30 (see FIG. 1) is directed toward the aerial image (step 11). In Exemplary Embodiment 2, the processor 21 determines the direction of gaze of a person recognized from an image captured by the camera 30.

In this regard, the memory 22 (see FIG. 1) according to Exemplary Embodiment 2 stores the following pieces of information: the position where the camera 30 is mounted; the direction in which the camera 30 captures an image; and Position P1 where a two-dimensional aerial image is formed.

Based on the pieces of information mentioned above, the processor 21 determines whether the gaze of a person recognized within an image captured by the camera 30 is directed toward an aerial image formed as a two-dimensional image.

The determination of the direction of gaze by the processor 21 is not an exact determination in a strict sense. Even if the determination is not exact in a strict sense, this does not pose any practical problem. This is because the control according to Exemplary Embodiment 2 is performed for purposes such as making a person notice an aerial image or increasing the interest of a person in an aerial image. Indeed, even if a person□s gaze is not strictly directed toward where an aerial image is formed, there is a possibility that, as the aerial image transforms from being two-dimensional to three-dimensional, the person may notice the aerial image. Further, there is no inconvenience involved for both a person who does not notice the aerial image and the provider of the advertisement.

If the person□s gaze is directed toward the aerial image, the processor 21 obtains an affirmative result at step 11. In this case, the processor 21 instructs that a three-dimensional aerial image be formed (step 3).

If the person□s gaze is directed not toward the aerial image, the processor 21 obtains a negative result at step 11. In this case, the processor 21 instructs that a two-dimensional aerial image be formed (step 4).

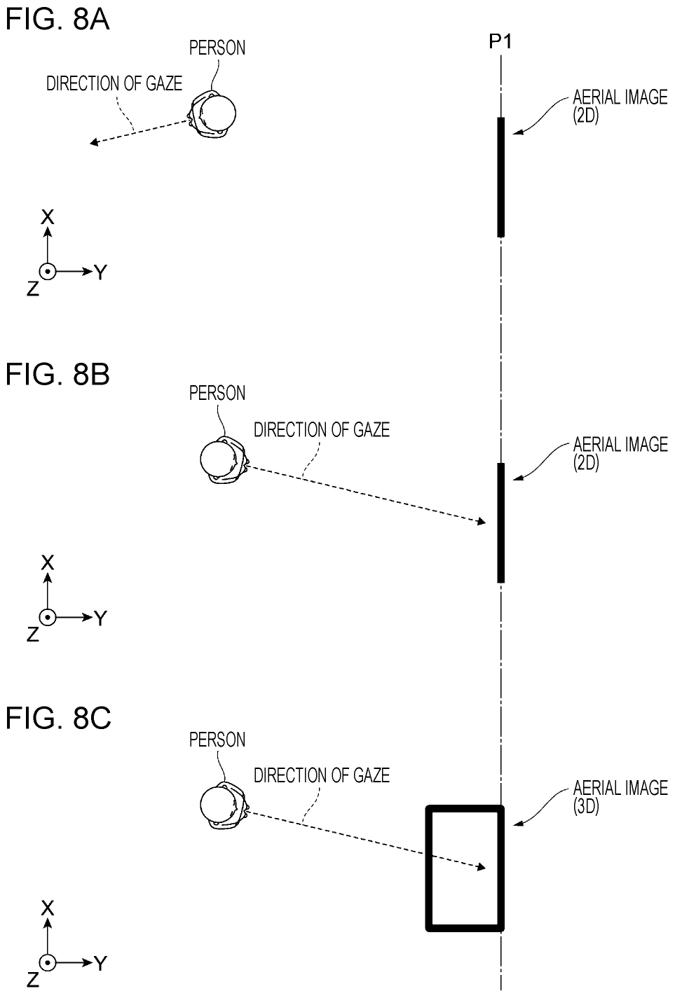

FIGS. 8A to 8C each illustrate how the shapes of aerial images formed in the air are switched. FIG. 8A illustrates a case in which a person□s gaze is directed not toward an aerial image, FIG. 8B illustrates a case in which a person□s gaze is directed toward an aerial image, and FIG. 8C illustrates a case in which a person□s gaze is directed toward an aerial image.

In FIGS. 8A to 8C as well, P1 represents the position where a two-dimensional aerial image is formed.

In the case of FIG. 8A, the direction of gaze is opposite to the direction toward an aerial image. If a person is not looking at an aerial image as in this case, the aerial image is formed in two dimensions.

In contrast, in the case of FIG. 8B, the direction of gaze is toward an aerial image. In this case, the processor 21 switches the aerial image to a three-dimensional shape as illustrated in FIG. 8C. This change in shape draws the attention of the person, thus increasing the likelihood of the aerial image being observed by the person. This means increased chance of the advertisement being observed by the person.

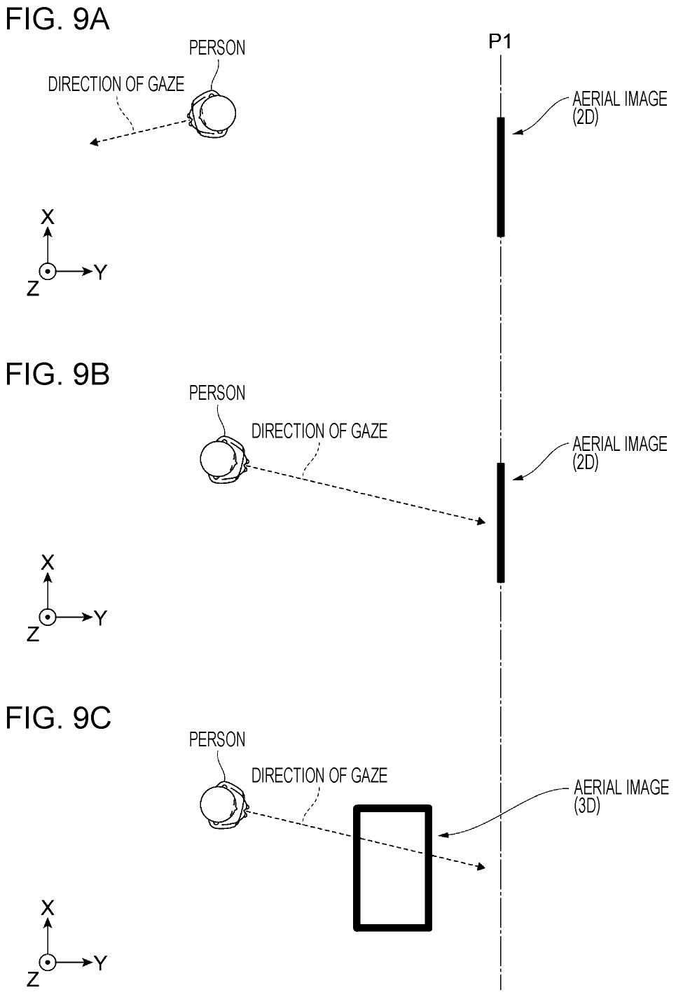

FIGS. 9A to 9C each illustrate another example of how the shapes of aerial images formed in the air are switched. FIG. 9A illustrates a case in which a person□s gaze is directed not toward an aerial image, FIG. 9B illustrates a case in which a person□s gaze is directed toward an aerial image, and FIG. 9C illustrates a case in which a person□s gaze is directed toward an aerial image. In FIGS. 9A to 9C, features corresponding to those in FIGS. 8A to 8C are denoted by the corresponding reference signs.

FIGS. 9A to 9C differ from FIGS. 8A to 8C in where a three-dimensional aerial image is formed. In the case of FIGS. 8A to 8C, the far side of the three-dimensional aerial image as seen from the person includes the plane in which the two-dimensional image is formed, or the far side of the three-dimensional aerial image is located near the plane.

However, in FIGS. 9A to 9C, the three-dimensional aerial image is formed at a position closer to the person than the position illustrated in FIGS. 8A to 8C is. In other words, if a three-dimensional aerial image is to be formed in FIGS. 9A to 9C, the three-dimensional aerial image appears immediately near the person. This is expected to increase the person□s interest in the aerial image.

In Exemplary Embodiment 2, where a person is located has no relation with the area used for the determination at step 2 in Exemplary Embodiment 1. This means that even if a person is located outside the area used for the determination at step 2, as long as the person□s gaze is directed toward an aerial image, the shape of the aerial image is switched from being two-dimensional to three-dimensional.

In Exemplary Embodiment 2, even if Position P1 where a two-dimensional aerial image is formed, and a person are located far away from each other, the aerial image is switched to a three-dimensional image. This is expected to effectively make the person notice the aerial image. This may lead to an increased chance that the person who has noticed the aerial image approaches the aerial image to check what the aerial image is.

In this regard, however, if a person and an aerial image are far too away from each other, even when the person notices the presence of the aerial image, the person is unable to see what the aerial image is from where the person is present. In this case, therefore, the change in the shape of the aerial image may not lead to a greater advertising effect.

Accordingly, in Exemplary Embodiment 2, the distance between a person and an aerial image may be added as a condition for the determination at step 11 as in Exemplary Embodiment 1.

Specifically, in one exemplary control, even when the gaze of a person is directed toward an aerial image, if the distance between the person and the aerial image is greater than or equal to a predetermined distance, or if the person is not located inside the area used in the determination at step 2 (see FIG. 2), a positive determination is not made at step 11.

With the above-mentioned control, if it is possible for a person to view the content of an aerial image, and the person□s gaze is directed toward the aerial image, then the aerial image may be transformed from being two-dimensional to three-dimensional, thus increasing the person□s attention to the aerial image.

In this case, even when the person and the aerial image are close to each other, if the person□s gaze is directed not toward the aerial image, the two-dimensional shape of the aerial image may be maintained. This is because changing the shape of the aerial image from two-dimensional to three-dimensional does not change the person□s attention to or interest in the aerial image unless the person is looking in the direction of the aerial image.

### Exemplary Embodiment 3

The following describes an exemplary process that can be used in forming an aerial image in three dimensions.

### EXAMPLE 1

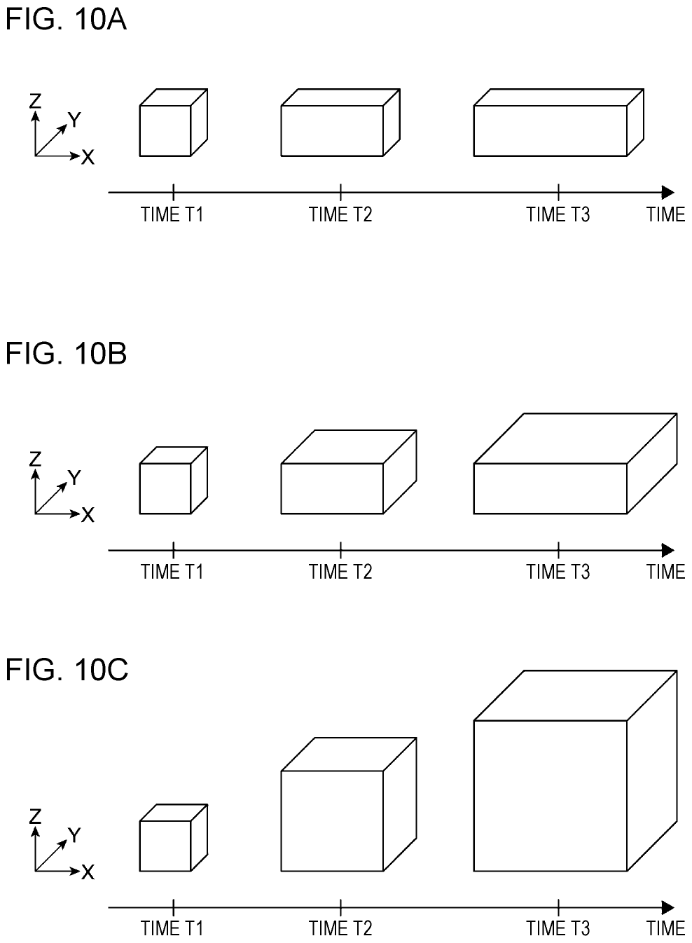

FIGS. 10A to 10C each illustrate an example in which an aerial image formed in three dimensions is enlarged in volume with the passage of time. FIG. 10A illustrates an example in which the aerial image is enlarged in volume in one direction, FIG. 10B illustrates an example in which the aerial image is enlarged in volume in two directions, and FIG. 10C illustrates an example in which the aerial image is enlarged in volume in three directions.

Although the example in each of FIGS. 10A to 10C focuses only on the volume of the aerial image, it is also possible to change the content of the aerial image in conjunction with the passage of time or with the enlargement of the aerial image, such as by changing the aerial image in color or brightness.

FIGS. 10A to 10C each illustrate, with time represented on the horizontal axis, how the shape of the aerial image at time T1 changes at times T2 and T3. In the case of FIGS. 10A to 10C, the aerial image has a cuboid shape at time T1.

The example in FIG. 10A represents enlargement in the X-axis direction. In this case, as seen from a person, the three-dimensional aerial image appears to be enlarged in the horizontal direction with the passage of time.

The example in FIG. 10B represents enlargement by the same factor in each of the X- and Y-axis directions. It is to be noted, however, that the enlargement factor may differ between the X-axis direction and the Y-axis direction. The enlargement factor may not necessarily be fixed but may change with the passage of time. The Y-axis direction is the direction of depth as seen from a person. Thus, in the case of FIG. 10B, the aerial image formed in three dimensions appears to increase in thickness in the depth direction with the passage of time.

The example in FIG. 10C represents enlargement by the same factor in each of the X-, Y-, and Z-axis directions. Thus, in the example in FIG. 10C, the aerial image is enlarged while keeping its cuboid shape. It is to be noted, however, that the enlargement factor may differ along each axis. The enlargement factor may not necessarily be fixed but may change with the passage of time. In the case of FIG. 10C, the aerial image formed in three dimensions appears to be enlarged in a uniform manner with the passage of time.

### EXAMPLE 2

Example 1 above is directed to an example of how an aerial image changes in shape as the aerial image is enlarged in volume with the passage of time.

The following describes differences in the direction of enlargement of a three-dimensional aerial image that changes in volume with the passage of time.

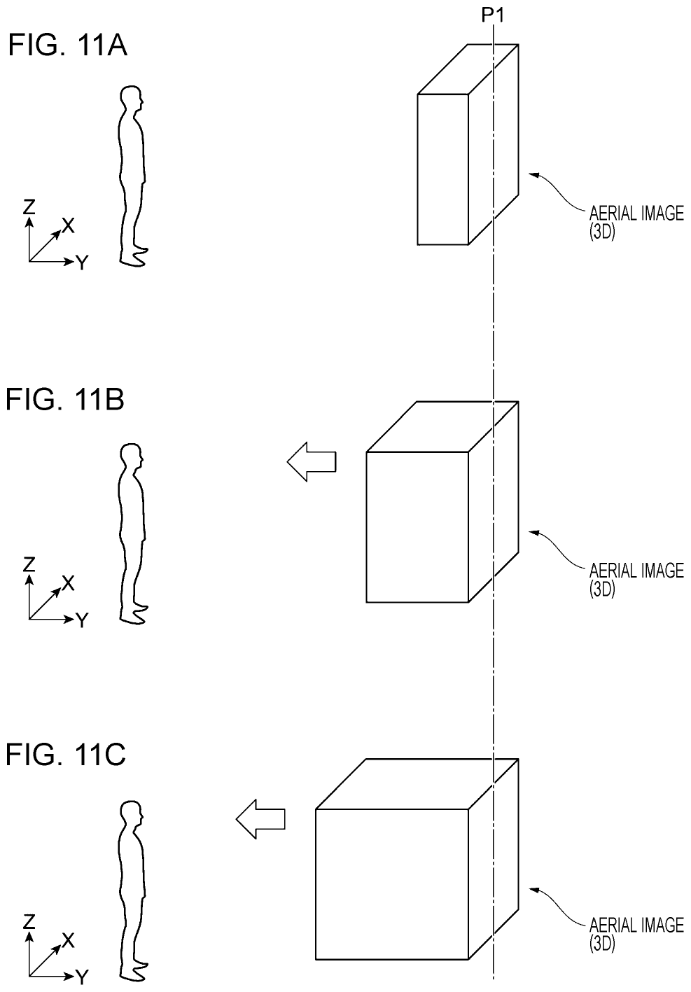

FIGS. 11A to 11C each illustrate a case in which, at the beginning of enlargement in volume, an aerial image is located at the same position as Position P1 where the aerial image has been previously formed in two dimensions. FIG. 11A illustrates the position and shape of the aerial image at time T1, FIG. 11B illustrates the position and shape of the aerial image at time T2, and FIG. 11C illustrates the position and shape of the aerial image at time T3.

The positioning of the aerial image at time T1 in FIGS. 11A to 11C corresponds to that in FIG. 5C or FIG. 8C. In the case of FIGS. 11A to 11C, the aerial image formed in three dimensions is enlarged with the passage of time in a direction toward a person. Specifically, the aerial image is enlarged in the Y-axis direction.

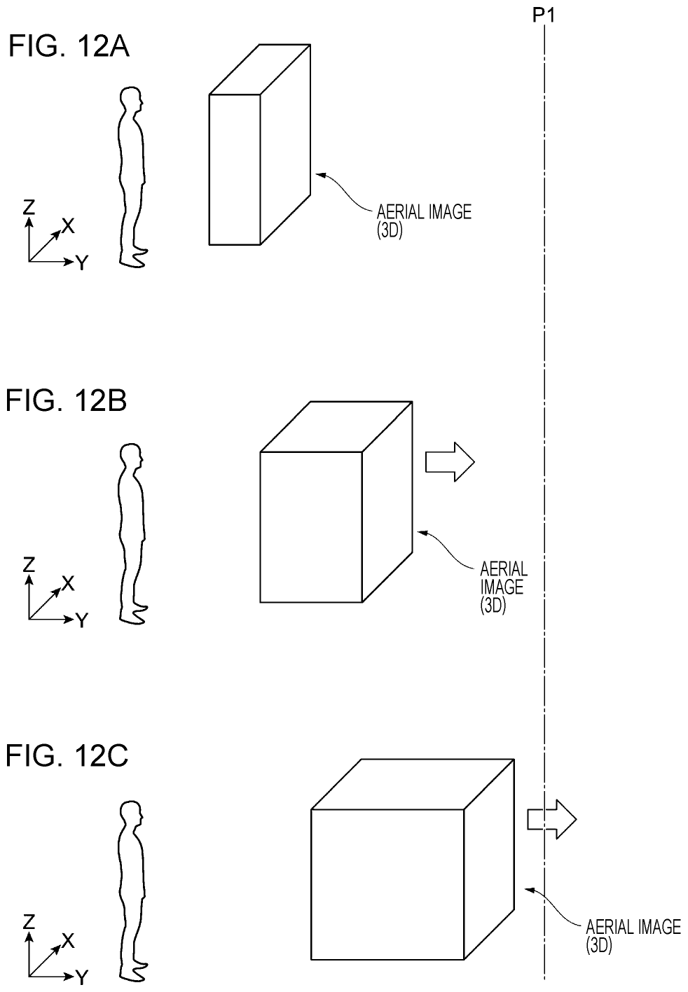

FIGS. 12A to 12C each illustrate a case in which, at the beginning of enlargement in volume, an aerial image is located at a position different from Position P1 where the aerial image has been previously formed in two dimensions. FIG. 12A illustrates the position and shape of the aerial image at time T1, FIG. 12B illustrates the position and shape of the aerial image at time T2, and FIG. 12C illustrates the position and shape of the aerial image at time T3.

The positioning of the aerial image at time T1 in FIGS. 12A to 12C corresponds to that in FIG. 6C or FIG. 9C. In the case of FIGS. 12A to 12C, the aerial image formed in three dimensions is enlarged with the passage of time in a direction away from a person, until the aerial image eventually approaches Position P1 where the aerial image has been previously formed in two dimensions. It is to be noted that in the case of FIGS. 12A to 12C, the aerial image is not only enlarged in the Y-axis direction, but also moves in the Y-axis direction with the passage of time. Specifically, the aerial image is moved in a direction away from the person. In other words, the aerial image formed in three dimensions is moved in a direction toward Position P1 where the aerial image is formed in two dimensions.

Even though the shape of an aerial image formed in three dimensions is the same between FIGS. 11A to 11C and FIGS. 12A to 12C at each point in time, the position where enlargement of the aerial image begins or the direction in which the aerial image is enlarged differs between FIGS. 11A to 11C and FIGS. 12A to 12C. This may make it possible to give a different impression to the person observing the aerial image.

### EXAMPLE 3

In the case of Example 2, an aerial image formed in three dimensions is enlarged in volume with the passage of time. The following describes an example in which enlargement of an aerial image in volume is controlled in relation to where a person is located.

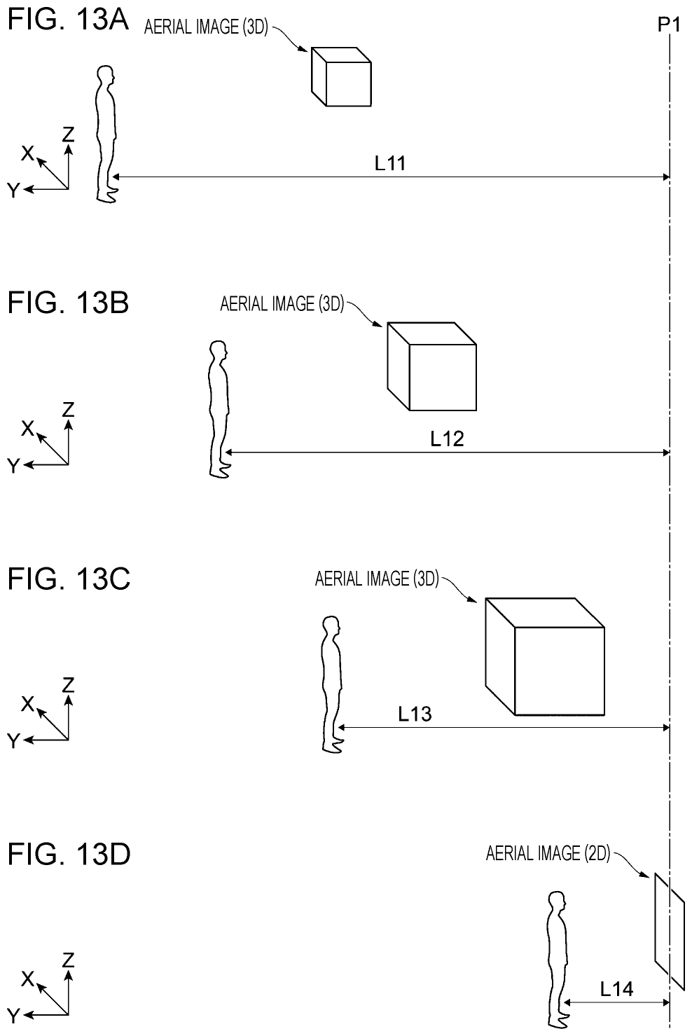

FIGS. 13A to 13D each illustrate an example of how to direct a person toward Position P1 where a two-dimensional aerial image is formed. FIG. 13A illustrates the shape of an aerial image immediately after being formed in three dimensions, FIG. 13B illustrates the shape of the aerial image with the person moving closer to Position P1, FIG. 13C illustrates the shape of the aerial image with the person moving further closer to Position P1, and FIG. 13D illustrates the shape of the aerial image with the person moving further closer until the person is just in front of Position P1. Position P1 in this case is where the aerial image is formed in two dimensions.

In FIGS. 13A to 13D as well, the aerial image is transformed so as to be enlarged in volume. In this case, however, the distance between the person and Position P1, rather than time, is used in controlling the volume of the aerial image.

For example, in the case of FIG. 13A in which the distance between the person and Position P1 is L11, the aerial image formed in three dimensions is positioned midway between Position P1 and the person. This positioning corresponds to that in FIG. 6C or FIG. 9C.

When, upon noticing the aerial image, the person moves closer to the aerial image, the volume of the aerial image is enlarged in accordance with the distance between the person and Position P1. In the case of FIGS. 13A to 13D, when the distance is L12(<L11), the aerial image has a larger volume than when the distance is L11, and when the distance is L13(<L12), the aerial image has a larger volume than when the distance is L12.

As with the examples mentioned above, the change in the volume of the aerial image at this time may be enlargement in one direction or enlargement in two directions. The example in each of FIGS. 13A to 13D represents enlargement in three directions. The enlargement factor may be fixed, or may be varied in accordance with the distance between the person and Position P1.

When the person moves to a position where a distance L14(<L13) between the person and Position P1 is less than a predetermined distance, the aerial image is controlled to have a two-dimensional shape as illustrated in FIG. 13D.

By changing the volume of an aerial image as illustrated in FIGS. 13A to 13D, a person interested in or intrigued by the aerial image may be directed toward a specific position. In FIGS. 13A to 13D, the person is directed toward Position P1 where the aerial image is formed in two dimensions, thus increasing the advertising effect.

The enlargement of the aerial image in volume may be stopped once the distance between the person and Position P1 becomes less than a predetermined distance.

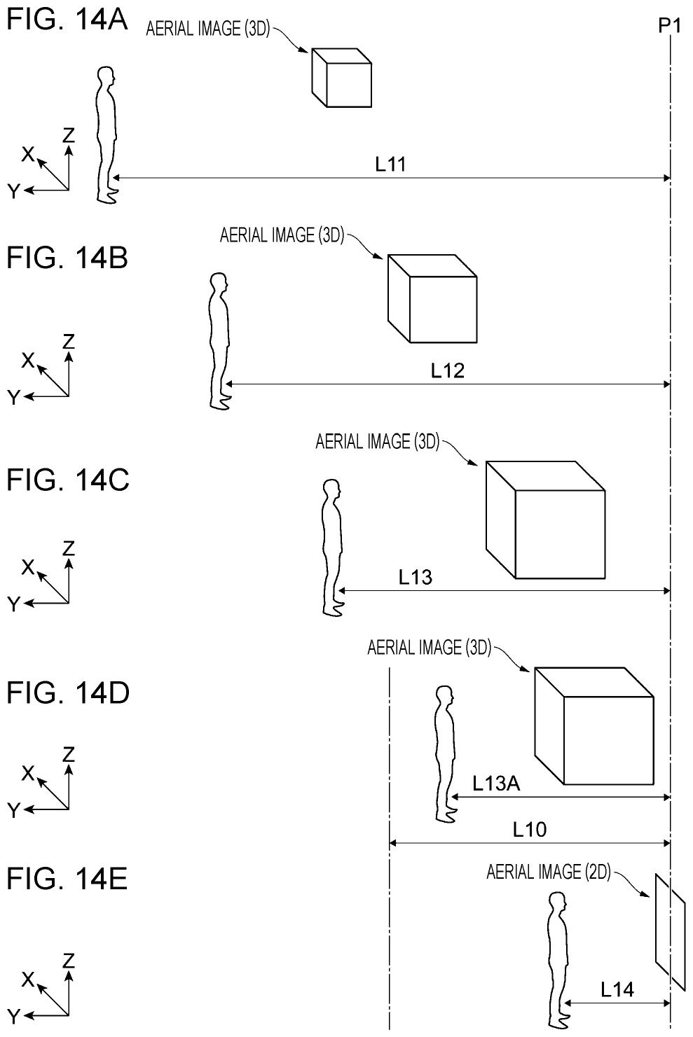

FIGS. 14A to 14E each illustrate another example of how to direct a person toward Position P1 where a two-dimensional aerial image is formed. FIG. 14A illustrates the shape of an aerial image immediately after being formed in three dimensions, FIG. 14B illustrates the shape of the aerial image with the person moving closer to Position P1, FIG. 14C illustrates the shape of the aerial image with the person moving further closer to Position P1, FIG. 14D illustrates the shape of the aerial image with the person moving further closer to Position P1, and FIG. 14E illustrates the shape of the aerial image with the person moving further closer until the person is just in front of Position P1. In FIGS. 14A to 14E, features corresponding to those in FIGS. 13A to 13D are denoted by the corresponding reference signs.

In the case of FIGS. 14A to 14E, enlargement of the aerial image is stopped on the condition that a distance Ll3A, which is the distance between the person and Position P1, has become less than a predetermined distance L10. Thus, the volume of the aerial image in FIG. 14C is the same as the volume of the aerial image in FIG. 14D.

A larger volume of an aerial image does not necessarily increase a person□s interest or attention. Further, there is a limit on the physical size in which an aerial image can be formed. For these reasons, the control as illustrated in FIGS. 14A to 14E is also provided.

### EXAMPLE 4

In the case of Examples 1 to 3 above, as an aerial image formed in three dimensions is enlarged, the center of the aerial image also moves. Alternatively, however, it is also possible to enlarge an aerial image with the center position of the aerial image fixed.

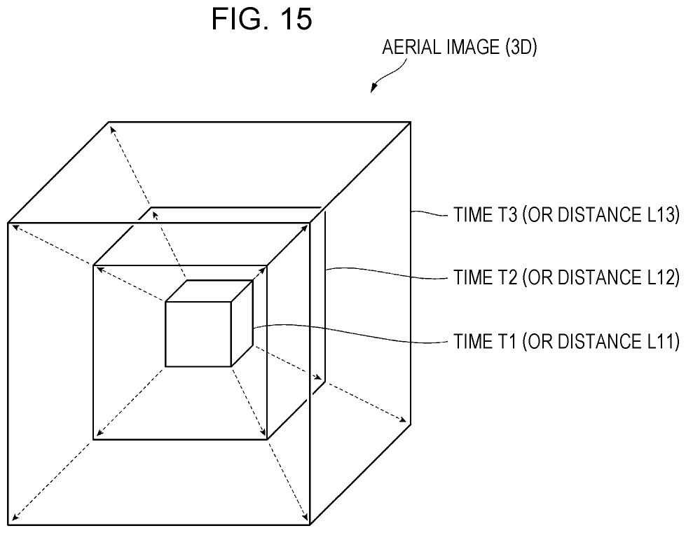

FIG. 15 illustrates an example in which an aerial image formed in three dimensions is enlarged in volume with the center of the aerial image fixed in position.

The aerial images illustrated in FIG. 15 each have the shape of a cube. FIG. 15 illustrates three aerial images with different volumes. In this regard, the smallest cube corresponds to the aerial image at time T1 in FIGS. 10A to 12C or the aerial image when the distance described above with reference to FIGS. 13A to 14E is L11. The second largest cube corresponds to the aerial image at time T2 in FIGS. 10A to 12C or the aerial image when the distance described above with reference to FIGS. 13A to 14E is L12. The largest cube corresponds to the aerial image at time T3 in FIGS. 10A to 12C or the aerial image when the distance described above with reference to FIGS. 13A to 14E is L13.

As described above, with the center of an aerial image fixed in position, the aerial image is enlarged in volume as time passes or as a person approaches the aerial image. This may also make it possible to increase the person□s attention to or interest in the advertisement represented as the aerial image.

### EXAMPLE 5

In the case of Examples 1 to 4 above, an object constituting an aerial image formed in three dimensions remains unchanged as the aerial image is enlarged in volume. Alternatively, however, it is also possible to control the object constituting the aerial image such that the content represented by the object evolves as the aerial image is enlarged in volume.

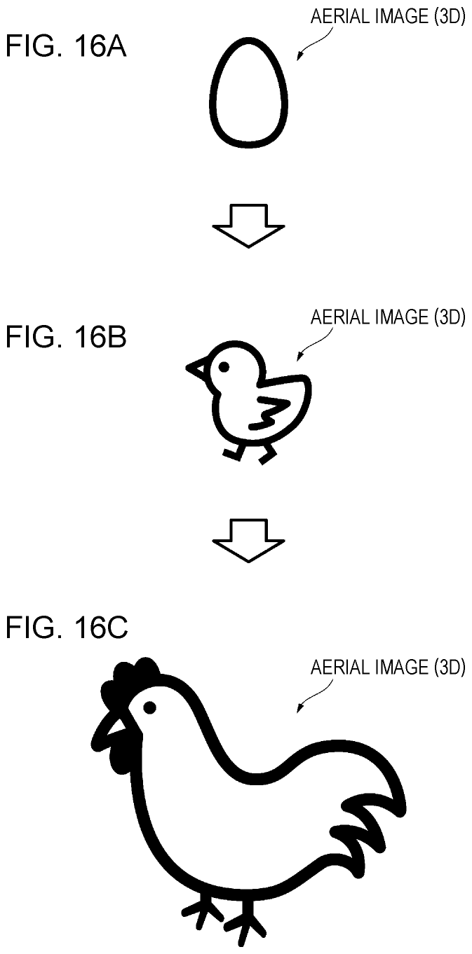

FIGS. 16A to 16C each illustrate an example in which an object constituting an aerial image formed in three dimensions is changed as the aerial image is enlarged in volume. FIG. 16A illustrates an exemplary object constituting the aerial image with the smallest volume, FIG. 16B illustrates an exemplary object constituting the aerial image with the second largest volume, and FIG. 16C illustrates an exemplary object constituting the aerial image with the largest volume.

In FIGS. 16A to 16C, the object evolves from an egg to a chick and then to a chicken. Another example of evolution of an object is when an object evolves from an egg to a tadpole and then to a frog. Of course, these examples are only illustrative.

The way in which an object changes as the object is enlarged in volume is not limited to evolution. For example, if the object is a living thing, the posture or facial expression of the same object may change. It is to be noted, however, that such changes also represent one form of a moving image.

### EXAMPLE 6

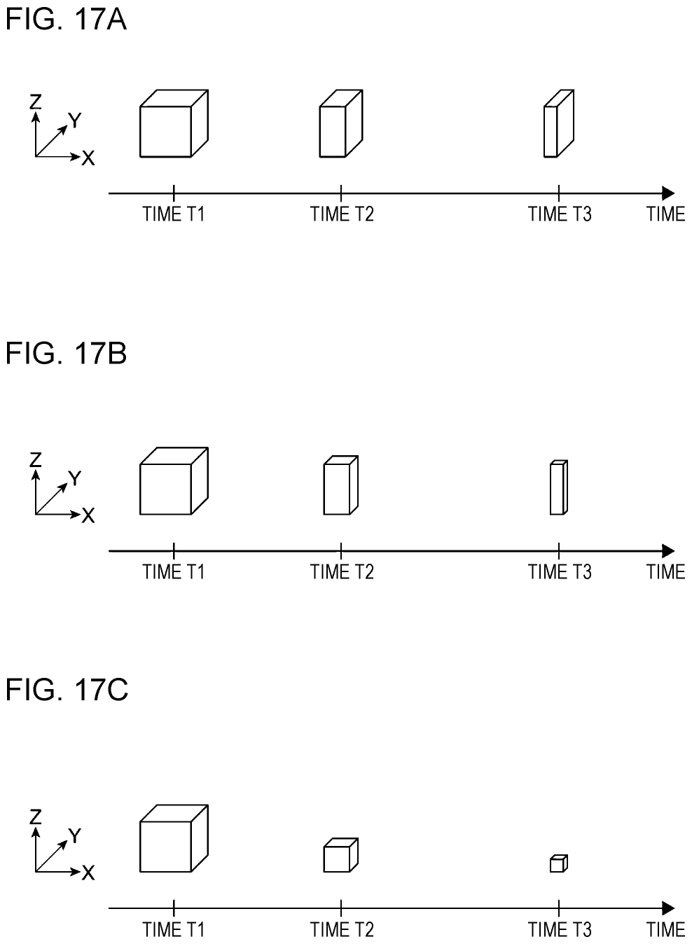

FIGS. 17A to 17C each illustrate an example in which an aerial image formed in three dimensions is reduced in volume with the passage of time. FIG. 17A illustrates an example in which the aerial image is reduced in volume in one direction, FIG. 17B illustrates an example in which the aerial image is reduced in volume in two directions, and FIG. 17C illustrates an example in which the aerial image is reduced in volume in three directions.

Although the example in each of FIGS. 17A to 17C focuses only on the volume of an aerial image, it is also possible to change the content of the aerial image in conjunction with the passage of time or with the reduction of the aerial image, such as by changing the aerial image in color or brightness.

FIGS. 17A to 17C each illustrate, with time represented on the horizontal axis, how the shape of the aerial image at time T1 changes at times T2 and T3. In the case of FIGS. 17A to 17C, the aerial image has a cuboid shape at time T1.

The example in FIG. 17A represents reduction in the X-axis direction. In this case, as seen from a person, the three-dimensional aerial image appears to be reduced in the horizontal direction with the passage of time.

The example in FIG. 17B represents reduction by the same factor in each of the X- and Y-axis directions. It is to be noted, however, that the reduction factor may differ between the X-axis direction and the Y-axis direction. The reduction factor may not necessarily be fixed but may change with the passage of time. The Y-axis direction is the direction of depth as seen from the person. Thus, in the case of FIG. 17B, the aerial image formed in three dimensions appears to decrease in thickness in the depth direction with the passage of time.

The example in FIG. 17C represents reduction by the same factor in each of the X-, Y-, and Z-axis directions. Thus, in the example in FIG. 17C, the aerial image is reduced while keeping its cuboid shape. It is to be noted, however, that the reduction factor may differ along each axis. The reduction factor may not necessarily be fixed but may change with the passage of time. In the example in FIG. 17C, the aerial image formed in three dimensions appears to be reduced in a uniform manner with the passage of time.

### EXAMPLE 7

Example 6 above is directed to an example of how an aerial image changes in shape as the aerial image is reduced in volume with the passage of time.

The following describes differences in the direction of reduction of a three-dimensional aerial image that changes in volume with the passage of time.

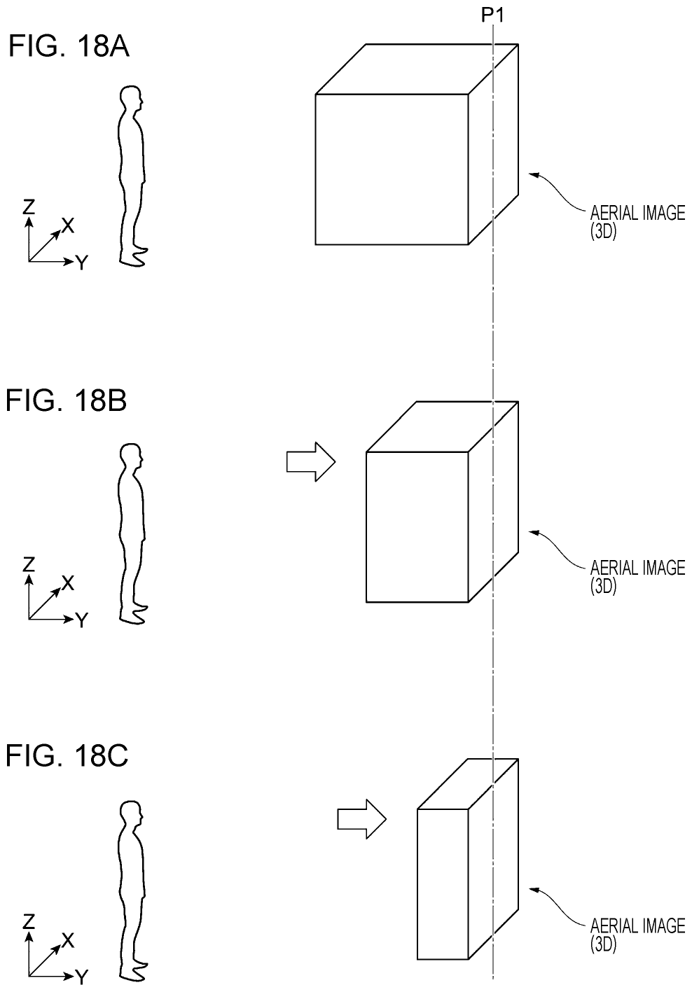

FIGS. 18A to 18C each illustrate a case in which, at the beginning of reduction in volume, an aerial image is located at the same position as Position P1 where the aerial image has been previously formed in two dimensions. FIG. 18A illustrates the position and shape of the aerial image at time T1, FIG. 18B illustrates the position and shape of the aerial image at time T2, and FIG. 18C illustrates the position and shape of the aerial image at time T3.

The positioning of the aerial image at time T1 in FIGS. 18A to 18C corresponds to that in FIG. 5C or FIG. 8C. In the case of FIGS. 18A to 18C, the aerial image formed in three dimensions is reduced with the passage of time in a direction away from a person. Specifically, the aerial image is reduced in the Y-axis direction.

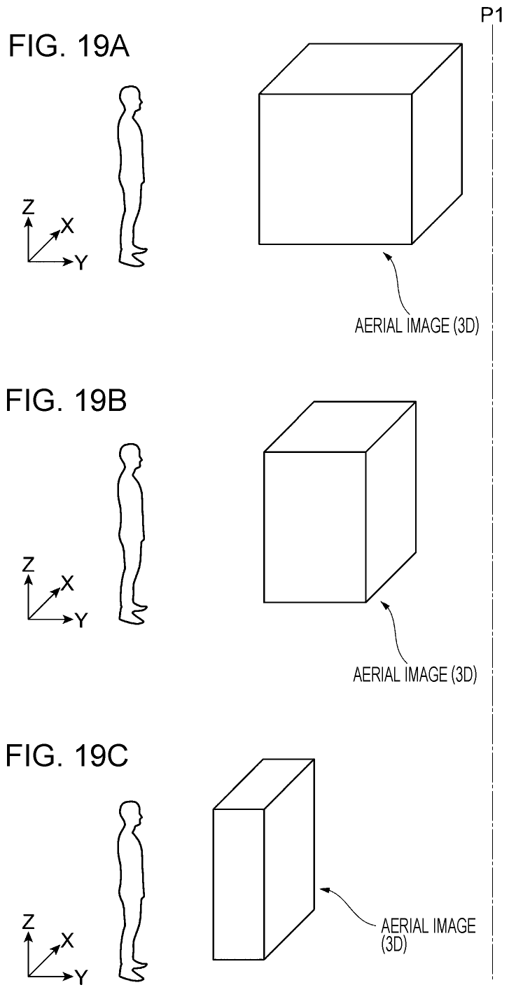

FIGS. 19A to 19C each illustrate a case in which, at the beginning of reduction in volume, an aerial image is located at a position different from Position P1 where the aerial image has been previously formed in two dimensions. FIG. 19A illustrates the position and shape of the aerial image at time T1, FIG. 19B illustrates the position and shape of the aerial image at time T2, and FIG. 19C illustrates the position and shape of the aerial image at time T3.

The positioning of the aerial image at time T1 in FIGS. 19A to 19C corresponds to that in FIG. 6C or FIG. 9C. In the case of FIGS. 19A to 19C, the aerial image formed in three dimensions is reduced with the passage of time in a direction toward a person. It is to be noted that in the case of FIGS. 19A to 19C, the aerial image is not only reduced in the Y-axis direction, but also moves in the Y-axis direction with the passage of time. Specifically, the aerial image is moved in a direction toward the person. In other words, the aerial image formed in three dimensions is moved in a direction away from Position P1 where the aerial image is formed in two dimensions.

Even through the shape of an aerial image formed in three dimensions is the same between FIGS. 18A to 18C and FIGS. 19A to 19C at each point in time, the position where reduction of the aerial image begins or the direction in which the aerial image is reduced differs between FIGS. 18A to 18C and FIGS. 19A to 19C. This may make it possible to give a different impression to the person observing the aerial image.

### EXAMPLE 8

In the case of Example 7, an aerial image formed in three dimensions is reduced in volume with the passage of time. The following describes an example in which reduction of an aerial image in volume is controlled in relation to where a person is located.

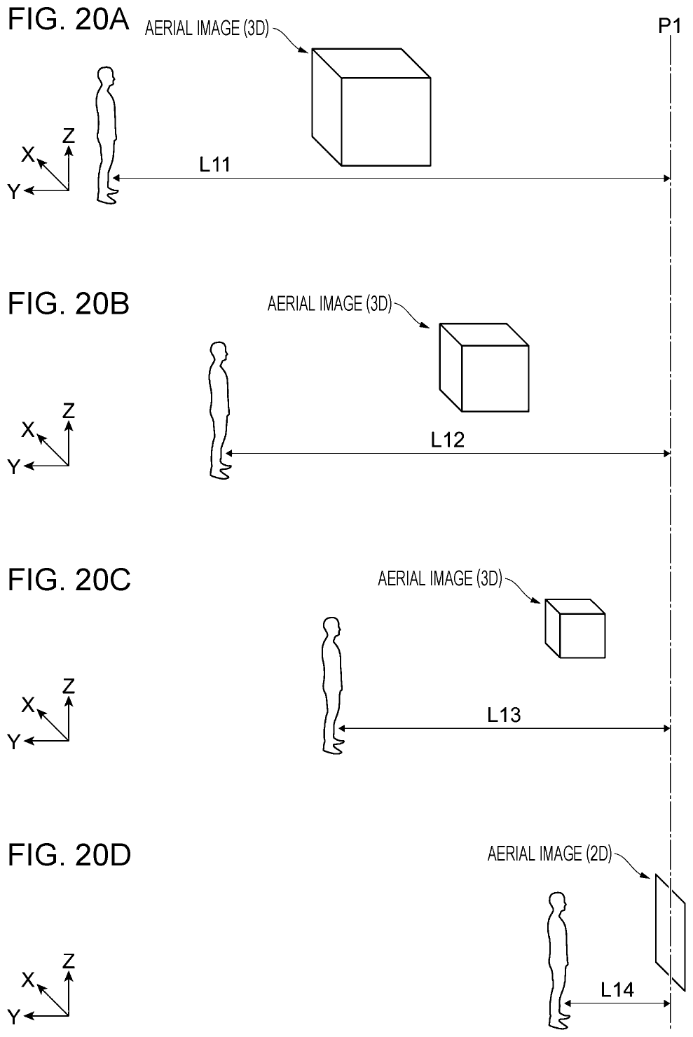

FIGS. 20A to 20D each illustrate an example of how to direct a person toward Position P1 where a two-dimensional aerial image is formed. FIG. 20A illustrates the shape of an aerial image immediately after being formed in three dimensions, FIG. 20B illustrates the shape of the aerial image with the person moving closer to Position P1, FIG. 20C illustrates the shape of the aerial image with the person moving further closer to Position P1, and FIG. 20D illustrates the shape of the aerial image with the person moving further closer until the person is just in front of Position P1. Position P1 in this case is where the aerial image is formed in two dimensions.

In FIGS. 20A to 20D as well, the aerial image is transformed so as to be reduced in volume. In this case, however, the distance between the person and Position P1, rather than time, is used in controlling the volume of the aerial image.

For example, in the case of FIG. 20A in which the distance between the person and Position P1 is L11, the aerial image formed in three dimensions is positioned midway between Position P1 and the person. This positioning corresponds to that in FIG. 6C or FIG. 9C.

When, upon noticing the aerial image, the person moves closer to the aerial image, the aerial image is reduced in volume in accordance with the distance between the person and Position P1. In the case of FIGS. 20A to 20D, when the distance is L12(<L11), the aerial image has a smaller volume than when the distance is L11, and when the distance is L13(<L12), the aerial image has a smaller volume than when the distance is L12.

As with the examples mentioned above, the change in the volume of the aerial image at this time may be reduction in one direction or reduction in two directions. The example in each of FIGS. 20A to 20D illustrates reduction in three directions. The reduction factor may be fixed, or may be varied in accordance with the distance between the person and Position P1.

When the person moves to a position where the distance L14(<L13) between the person and Position P1 is less than a predetermined distance, the aerial image is controlled to have a two-dimensional shape as illustrated in FIG. 20D.

By changing the volume of an aerial image as illustrated in FIGS. 20A to 20D, a person interested in or intrigued by the aerial image may be directed toward a specific position. In FIGS. 20A to 20D, the person is directed toward Position P1 where the aerial image is formed in two dimensions, thus increasing the advertising effect.

The reduction of the aerial image in volume may be stopped once the distance between the person and Position P1 becomes less than a predetermined distance.

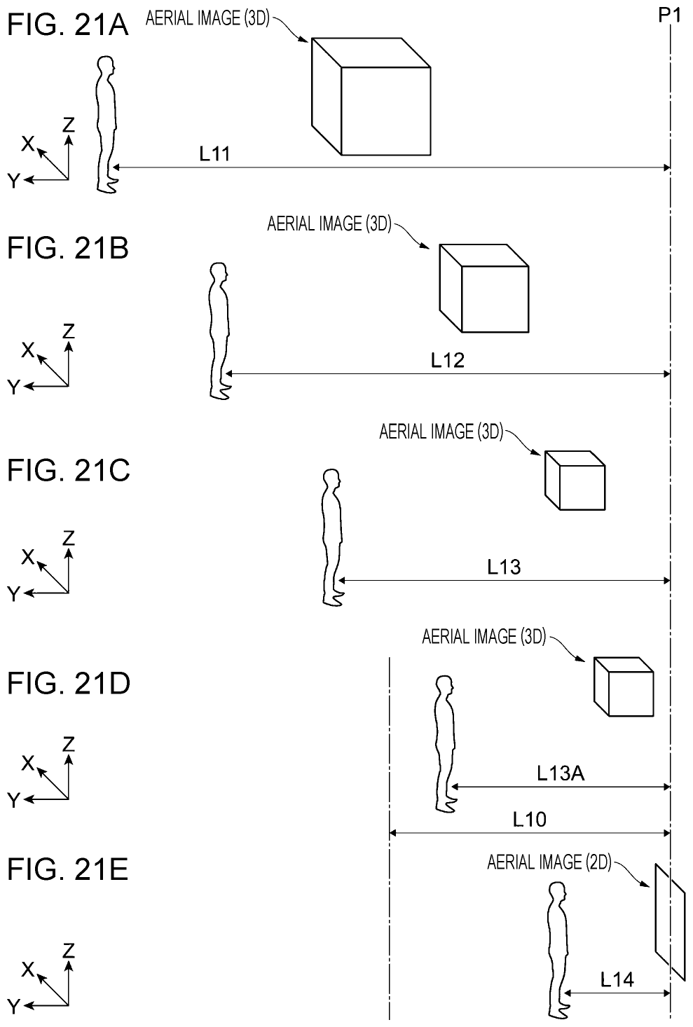

FIGS. 21A to 21E each illustrate another example of how to direct a person toward Position P1 where a two-dimensional aerial image is formed. FIG. 21A illustrates the shape of an aerial image immediately after being formed in three dimensions, FIG. 21B illustrates the shape of the aerial image with the person moving closer to Position P1, FIG. 21C illustrates the shape of the aerial image with the person moving further closer to Position P1, FIG. 21D illustrates the shape of the aerial image with the person moving further closer to Position P1, and FIG. 21E illustrates the shape of the aerial image with the person moving further closer until the person is just in front of Position P1. In FIGS. 21A to 21E, features corresponding to those in FIGS. 20A to 20D are denoted by the corresponding reference signs.

In the case of FIGS. 21 to 21E, reduction of the aerial image is stopped on the condition that the distance Ll3A between the person and Position P1 has become less than the predetermined distance L10. Thus, the volume of the aerial image in FIG. 21C is the same as the volume of the aerial image in FIG. 21D.

Reducing an aerial image too much in volume makes seeing of the aerial image itself difficult. For this reason, the control illustrated in FIGS. 21A to 21E is also provided.

### EXAMPLE 9

In the case of Examples 6 to 8 above, as an aerial image formed in three dimensions is reduced, the center of the aerial image also moves. Alternatively, however, it is also possible to reduce an aerial image with the center position of the aerial image fixed.

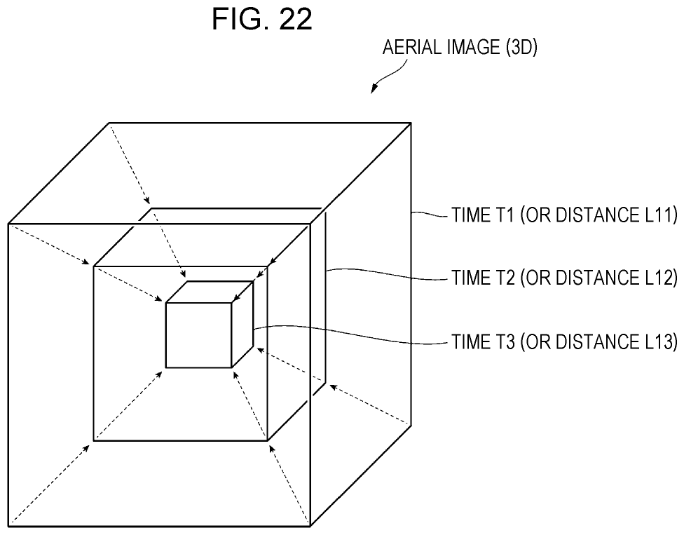

FIG. 22 illustrates an example in which an aerial image formed in three dimensions is reduced in volume with the center of the aerial image fixed in position.

The aerial images illustrated in FIG. 22 each have the shape of a cube. FIG. 22 illustrates three aerial images with different volumes. In this regard, the largest cube corresponds to the aerial image at time T1 in FIGS. 17A to 19C or the aerial image when the distance described above with reference to FIGS. 20A to 21E is L11. The second largest cube corresponds to the aerial image at time T2 in FIGS. 17A to 19C or the aerial image when the distance described above with reference to FIGS. 20A to 21E is L12. The smallest cube corresponds to the aerial image at time T3 in FIGS. 17A to 19C or the aerial image when the distance described above with reference to FIGS. 20A to 21E is L13.

As described above, with the center of an aerial image fixed in position, the aerial image is reduced in volume as time passes or as a person approaches the aerial image. This may also make it possible to increase the person□s attention to or interest in the advertisement represented as the aerial image.

### EXAMPLE 10

In the case of Examples 6 to 9 above, an object constituting an aerial image formed in three dimensions remains unchanged as the aerial image is reduced in volume. Alternatively, however, it is also possible to control the object constituting the aerial image such that the content represented by the object evolves backward as the aerial image is enlarged in volume.

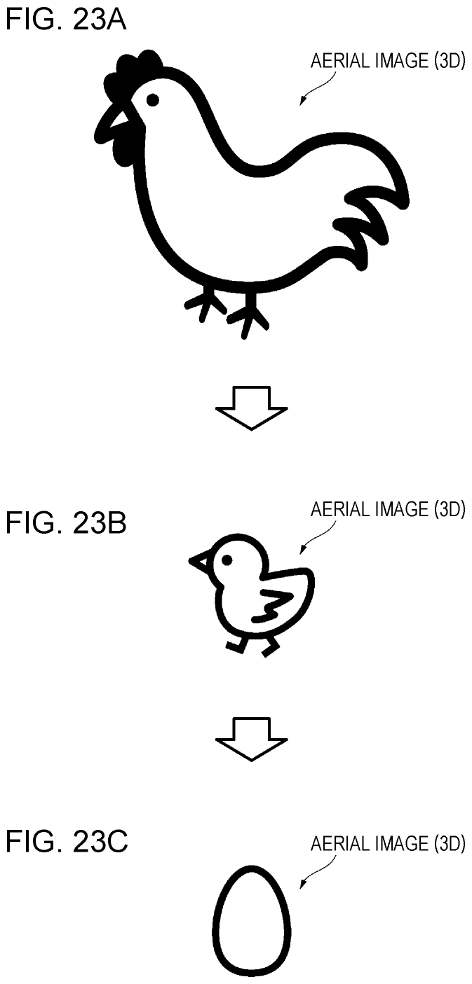

FIGS. 23A to 23C each illustrate an example in which an object constituting an aerial image formed in three dimensions is changed as the aerial image is reduced in volume. FIG. 23A illustrates an exemplary object constituting the aerial image with the largest volume, FIG. 23B illustrates an exemplary object constituting the aerial image with the second largest volume, and FIG. 23C illustrates an exemplary object constituting the aerial image with the smallest volume.

In FIGS. 23A to 23C, the object evolves backward from being a chicken to a chick and then to an egg. Another example of backward evolution of an object is when an object evolves backward from being a frog to a tadpole and then to an egg. Of course, the above examples are only illustrative.

The way in which an object changes as the object is reduced in volume is not limited to backward evolution. For example, if the object is a living thing, the posture or facial expression of the same object may change. It is to be noted, however, that such changes also represent one form of a moving image.

### Exemplary Embodiment 4

With reference to Exemplary Embodiment 4, the following describes a case in which the emotion of a person seeing or observing an aerial image is inferred from the person□s facial expression, and the content of the aerial image is changed accordingly.

Exemplary Embodiment 4 also uses the information processing system 1 (see FIG. 1) illustrated in FIG. 1.

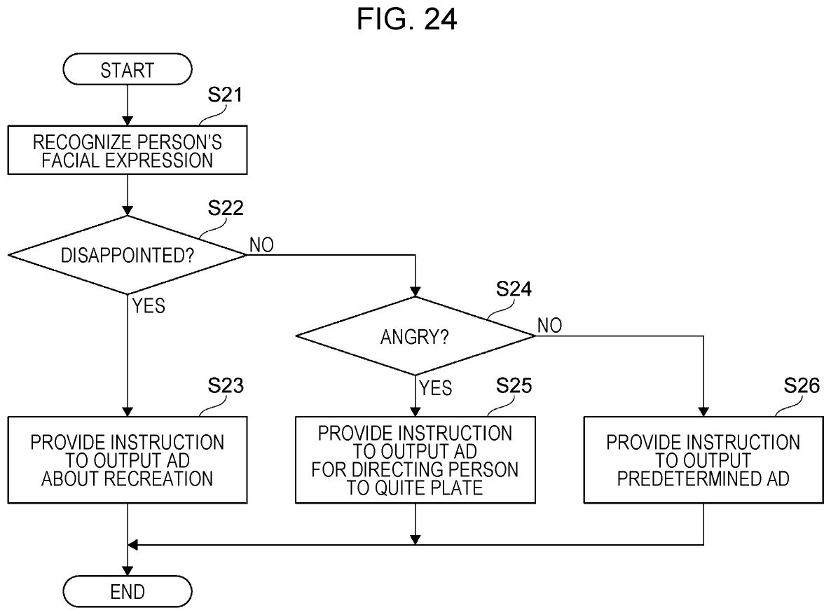

FIG. 24 is a flowchart illustrating an exemplary process that switches the contents of aerial images in accordance with Exemplary Embodiment 4. The process illustrated in FIG. 24 is implemented through execution of a program by the processor 21 (see FIG. 1).

First, the processor 21 recognizes, from an image captured by the camera 30 (see FIG. 1), the facial expression of a person located in the vicinity of an aerial image (step 21). In Exemplary Embodiment 4, the following three kinds of facial expressions are assumed to be recognized: disappointed, angry, and pleased. Of course, the specific kinds of facial expressions to be recognized, or the number of such facial expressions are only illustrative.

Subsequently, the processor 21 determines the recognized facial expression. In the case of FIG. 24, the processor 21 determines whether the person is recognized to be disappointed (step 22).

If an affirmative determination is made at step 22, the processor 21 instructs that an advertisement about recreation be output to cheer up the person (step 23).

If a negative determination is made at step 22, the processor 21 determines whether the person is recognized to be angry (step 24).

If an affirmative determination is made at step 24, the processor 21 instructs that an advertisement for directing the person to a quiet place be output to make the person calm down (step 25).

If a negative determination is made at step 24, the processor 21 instructs that a predetermined advertisement be output (step 26). In this regard, a case in which a negative determination is made at step 24 in FIG. 24 is when the person is recognized to be pleased from the person□s facial expression.

By combining the control according to Exemplary Embodiment 4, in which the content of an advertisement is changed by using information identified from a person□s facial expression, with the processes according to the above-mentioned exemplary embodiments, information is presented in diverse ways to a person who sees or observes an aerial image.

### Other Exemplary Embodiments

Although exemplary embodiments of the present disclosure have been described above, the technical scope of the present disclosure is not limited to the above exemplary embodiments. It is apparent from the description of the claims that various modifications or improvements of the exemplary embodiments also fall within the technical scope of the present disclosure.

For example, although the aerial-image forming apparatus 10 (see FIG. 1) and the controller 20 (see FIG. 1) have been described in the above exemplary embodiments as being independent from each other, the aerial-image forming apparatus 10 and the controller 20 may be integrated with each other.

The controller 20 according to the above exemplary embodiments may be a so-called computer or an information terminal such as a smartphone, or may be a server installed on the Internet.

Although the exemplary embodiments above are directed to the case in which an aerial image is used for an advertisement, the content of an aerial image is not limited to an advertisement.

Although the exemplary embodiments above are directed to the case in which the basic shape of an aerial image is two-dimensional, the basic shape may be three-dimensional.

Although the exemplary embodiments above are directed to the case in which a two-dimensional image is formed as an aerial image, a two-dimensional image may be displayed on a planar display with a physical display surface, such as a liquid crystal display or an organic electro-luminescence (EL) display. In such a case, the processor 21 may control the switching between formation of an aerial image by the aerial-image forming apparatus 10 that forms an aerial image, and displaying of an image on the planar display.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to, in accordance with a state of a person in a vicinity of an image, instruct that a change be made to the image, the image being an image to be formed in air, the change being one of a change in dimensionality of the image and a change in size of the image.

2. The information processing apparatus according to claim 1,
wherein the processor is configured to, in accordance with whether a person is present in the vicinity of the image, switch how to form the image.

3. The information processing apparatus according to claim 2,
wherein the processor is configured to:
in response to not detecting presence of a person in the vicinity of the image, instruct that the image be formed in two dimensions; and
in response to detecting presence of a person in the vicinity of the image, instruct that the image be formed in three dimensions.

4. The information processing apparatus according to claim 1,
wherein the processor is configured to, in accordance with whether gaze of a person is directed toward the image, switch how to form the image.

5. The information processing apparatus according to claim 4,
wherein the processor is configured to:
in response to not detecting gaze of a person toward the image, instruct that the image be formed in two dimensions; and
in response to detecting gaze of a person toward the image, instruct that the image be formed in three dimensions.

6. The information processing apparatus according to claim 3,
wherein a position of the image formed in three dimensions is closer to a person than a position of the image formed in two dimensions is.

7. The information processing apparatus according to claim 6,
wherein the processor is configured to, if the image is formed in three dimensions, control enlargement of the image in volume.

8. The information processing apparatus according to claim 7,
wherein the image formed in three dimensions is enlarged in volume with passage of time.

9. The information processing apparatus according to claim 8,
wherein the position of the image formed in three dimensions is controlled to move closer with passage of time to the position of the image formed in two dimensions.

10. The information processing apparatus according to claim 7,
wherein the image formed in three dimensions is enlarged in volume as a person approaches the position of the image formed in two dimensions.

11. The information processing apparatus according to claim 10,
wherein enlargement of the image formed in three dimensions is stopped when a distance between the position of the image formed in two dimensions and a person reaches a predetermined value.

12. The information processing apparatus according to claim 7,
wherein the image formed in three dimensions is enlarged in volume with its center position fixed.

13. The information processing apparatus according to claim 7,
wherein the image formed in three dimensions is enlarged in volume in a direction toward a person from the position of the image formed in two dimensions.

14. The information processing apparatus according to claim 7,
wherein the image formed in three dimensions comprises an object that changes as the image is enlarged.

15. The information processing apparatus according to claim 14,
wherein content represented by the object evolves as the image formed in three dimensions is enlarged.

16. The information processing apparatus according to claim 6,
wherein the processor is configured to control reduction in volume of the image formed in three dimensions.

17. The information processing apparatus according to claim 16,
wherein the image formed in three dimensions is reduced in volume with passage of time.

18. The information processing apparatus according to claim 17,
wherein the position of the image formed in three dimensions is controlled to move closer with passage of time to a position where a person is located.

19. The information processing apparatus according to claim 16,
wherein the image formed in three dimensions is reduced in volume as a person approaches the position of the image formed in two dimensions.

20. The information processing apparatus according to claim 19,
wherein reduction of the image formed in three dimensions is stopped when a distance between the position of the image formed in two dimensions and a person reaches a predetermined value.

21. The information processing apparatus according to claim 16,
wherein the image formed in three dimensions is reduced in volume with its center position fixed.

22. The information processing apparatus according to claim 16,
wherein the image formed in three dimensions is reduced in volume in a direction toward the position of the image formed in two dimensions, from a position where a person is located.

23. The information processing apparatus according to claim 16,
wherein the image formed in three dimensions comprises an object that changes as the image is reduced.

24. The information processing apparatus according to claim 23,
wherein content represented by the object evolves backward as the image formed in three dimensions is reduced.

25. The information processing apparatus according to claim 1,
wherein the processor changes content of the image in accordance with a facial expression of a person in the vicinity of the image.

26. A non-transitory computer readable medium storing a program causing a computer to execute a process, the process comprising,
in accordance with a state of a person in a vicinity of an image, instructing that a change be made to the image, the image being an image to be formed in air, the change being one of a change in dimensionality of the image and a change in size of the image.
